(19) United States
(12) Patent Application Publication
(10) Pub. No.: US 2007/0193532 A1
(43) Pub. Date: Aug. 23, 2007

(54) Canine apparel

(76) Inventor: Michael T. Shelton, McKinney, TX (US)

Correspondence Address: LAW OFFICE OF STEVEN B. LEAVITT, L.L.P., P.O. BOX 537, ROWLETT, TX, 75030-0537, US

(21) Appl. No.: 11/348,426

(22) Filed: Feb. 6, 2006

(51) Int. Cl. A01K 13/00

(52) U.S. Cl. 119/850

(57) ABSTRACT

The present invention is an article of apparel that can relatively easily enclose the body of a dog to retain undesirable debris located on or about the body of the animal. Thereby, dander, mud, dirt, water and other materials commonly found on and around a dog's body may be retained within the article of apparel keeping a vehicle, house, and other similar locations visited by the dog relatively clean. The apparel is made of a lightweight, washable, durable material that is preferably breathable.

### BACKGROUND OF THE INVENTION

1. Technical Field

The present invention relates to the field of canines and more particularly to the area of apparel for canines.

2. Description of Related Art

Many people own one or more canines and desire to have these animals in areas that are preferred to be kept clean. Often the problem arises that a wet or dirty canine needs to be transported in a vehicle or brought inside a dwelling. For example, owners of hunting canine will often train the canine to fetch birds or other prey. Often the training for and the practice of using a canine for hunting involves water resulting in the canine getting very wet and dirty. When it is time to take the canine home, the animal must be dried and cleaned thoroughly before letting the canine inside the vehicle passenger or made to ride in a pickup truck bed if available. If the canine is not dried and cleaned thoroughly, then the person risks having the interior of the vehicle getting dirty, wet, and foul smelling.

A similar dilemma arises when a canine is let to venture outside during a rainy, snowy, or otherwise generally wet day or if an outside area is wet or muddy. The canine may become wet, muddy, foul smelling, or any combination thereof. Hence, the owner may be reluctant to let the canine back into the dwelling.

Another situation arises when canines that are being used as service animals, such as for example for the blind, need to brought into environments or enclosures where others may be allergic to canine dander. One such occurrence which can be particularly problematic is when a canine is brought into a relatively confined space such as a passenger compartment of an airplane. If a fellow passenger is allergic to canine dander, the service animal may need to be removed from its human companion or the allergic passenger must leave or suffer.

What is needed is an article of apparel that can relatively easily enclose a canine and keep a vehicle, house, or other enclosure relatively clean of dander, mud, dirt, water or other material. It would be beneficial if the article was made of a lightweight, durable, breathable, washable material.

On occasion service animals, such as search and rescue canines, are used in areas that have relatively hazardous environments. Having something that could provide a protective barrier to the canine's skin would be beneficial. Again, it would be beneficial if the article was made of a lightweight, durable, breathable, washable material.

Also, canines who are recovering from surgery and have stitches, with hot spots (acute moist dermatitis), dermatitis, allergies that cause skin eruptions, itching, other skin problems are often forced to wear elongated collars around their necks. These collars are commonly known as an Elizabethan collars. The collar prevents the canine from licking or irritating the affected area but is awkward for the canine to wear and some canines will become extremely agitated while wearing the collar. It would be beneficial if the canine could wear a lightweight, durable, breathable, washable article instead of the Elizabethan collar.

### SUMMARY OF THE INVENTION

The present invention is an apparel that can relatively easily enclose a canine and keep a vehicle, house, or other enclosure relatively clean of dander, mud, dirt, water or other material. The apparel is made of a lightweight, washable, durable material that is preferably breathable. Examples of such material include but are not limited to nylon, breathable neoprene, or Gore-Tex®. The apparel fully encloses every portion of the canine except the head.

To insert a canine into the apparel, the feet are first inserted into the proper leg portion and then the sides of the apparel are brought up and secured by an attachment means along the back of the canine. The attachment means may be a zipper, Velcro®, adhesive, buttons, hook-and-loop, snaps, or some other similar attachment means. The apparel may also be secured around the canine's neck with an elastic band. In one embodiment, each leg portion contains a removable foot portion so the canine's feet can be exposed and cleaned. Additionally, the apparel may contain a strap or harness that can be used to lift the canine into a vehicle or other raised area.

Also, the apparel may be used in place of an Elizabethan collar or to apply medicine such a flee powder to the canine. Because the apparel can be made of a breathable material, the canine can wear the article for an extended period while recovering from surgery, letting wounds heal, or for enabling the proper application of medicine to the canine.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a side view of the present invention in use;

FIG. 2 is a top view of the apparel the present invention;

FIG. 3 is a side view of the feet portion of the present invention; and

FIG. 4 is a side view of an alternate embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals

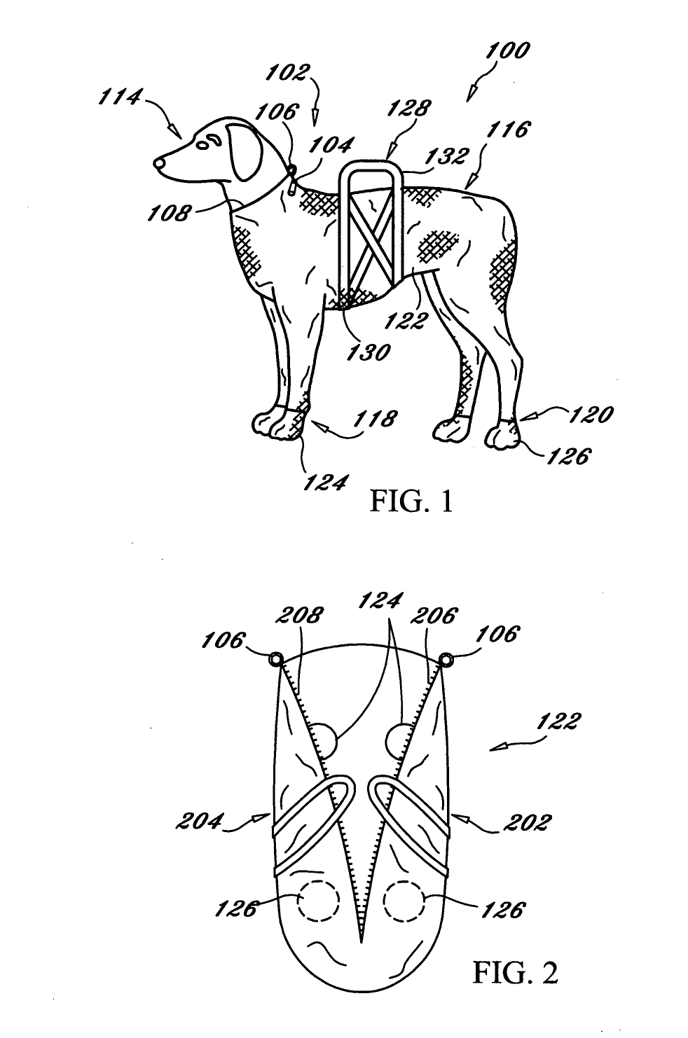

FIG. 1 shows canine 100 enclosed in apparel 102. Canine 100 has a head 114, body 116, front feet 118, and hind feet 120. Apparel 102 covers every part of canine 100 except head 114. Apparel contains body portion 122, front feet portion 124, and hind feet portion 126. Body portion 122 covers body 116, front feet portion 124 covers front feet 118, and hind feet portion 126 covers hind feet 120 of canine 100. If canine 100 has a tail, then the tail in contained within body portion 122 of apparel 102. Apparel 102 also contains closure means 104, leash attachment means 106, and may contain elastic 108.

Preferably, apparel 102 is comprised of a lightweight, washable, durable, breathable material. Examples of such material include but are not limited to nylon, breathable neoprene, other breathable material such as Gore-Tex®. In an alternate embodiment, apparel 102 is comprised of a relatively inexpensive disposable material such a paper, plastic, or paper lined with plastic wherein apparel 102 can be relatively easily discarded after use. In yet another embodiment, apparel 100 is comprised of a material that is relatively non-pours and does not allow any hair, dandier, or other potential allergens to escape the confines of apparel 102. In this manner, apparel 100 may be used as an allergy suit to allow canine 100 to be around those with severe allergies to canines. Preferably, when canine 100 is wearing apparel 102, canine 100 can walk, sit, and lay down relatively easily.

As shown in FIG. 2, body portion 122 has a right side 202 and a left side 204. Right side 202 contains attachment means 206. In an alternate embodiment, left side 204 contains attachment means 206 and in the interest of clarity and conciseness further reference will only be made to right side 202 containing attachment means 206. Attachment means 206 may be adhesive or one part of a mechanical attachment means such as one or more snaps, buttons, zippers, hook-and-loop fasteners such as Velcro®, magnets, or any other mechanical fastener that requires the mating of two parts.

If attachment means 206 is one part of a mechanical attachment means, then left side 204 contains mating attachment means 208. Mating attachment means 208 is the mating part of attachment means 206. For example, if attachment means 206 is a hook, then mating attachment means 208 may be a loop. Preferably closure means 104, FIG. 1, is a zipper.

In use, canine 100 is inserted into apparel 102 by first inserting front feet 118 into front feet portion 124 and then inserting hind feet 120 into hind feet portion 126. Alternatively, hind feet 120 may first be inserted into hind feet portion 126 then front feet 118 may be inserted into front feet portion 124. After the front feet 118 and hind feet 120 of canine 100 have been inserted into their respective portion of apparel 102, right side 202 and a left side 204 are secured together via closure means 104 and apparel 102 covers every part of canine 100 except head 114. If canine 100 has a tail, then the tail is tucked into apparel 102 before right side 202 and left side 204 are secured together such that the tail is contained within body portion 122 of apparel 102.

Elastic 108 may be used to help secure apparel 102 around canine's 100 neck. Leash attachment means 106 is at least one D-ring and is preferably two D-rings, one on right side 202 and one on left side 204. When a leash is attached to leash attachment means 106, the D-rings are joined together and aid in keeping apparel 102 closed and secured around canine 100.

As shown in FIG. 1, apparel 102 may also contain lifting straps 128. Lifting straps 128 aid in lifting canine 100 into a car or truck or other elevated area. Lifting straps 128 are preferably comprised of a strong flexible material such as nylon and contain support 130 and handle 132. Support 130 is fixedly attached to body portion 122 of apparel 102 and preferably extends from right side 202 to left side 204 and around canine's 100 mid-section. Handle 132 are attached to support 130 and extend above canine 100 such that a user can grasp handle 132 relatively easy.

When a user grasps handle 132 and begins to pull upward, the upward force is transferred to support 130 and onto the mid-section of canine 100. The upward force raises the mid-section of canine 100 and aids in lifting canine 100 into a car or truck or other elevated area.

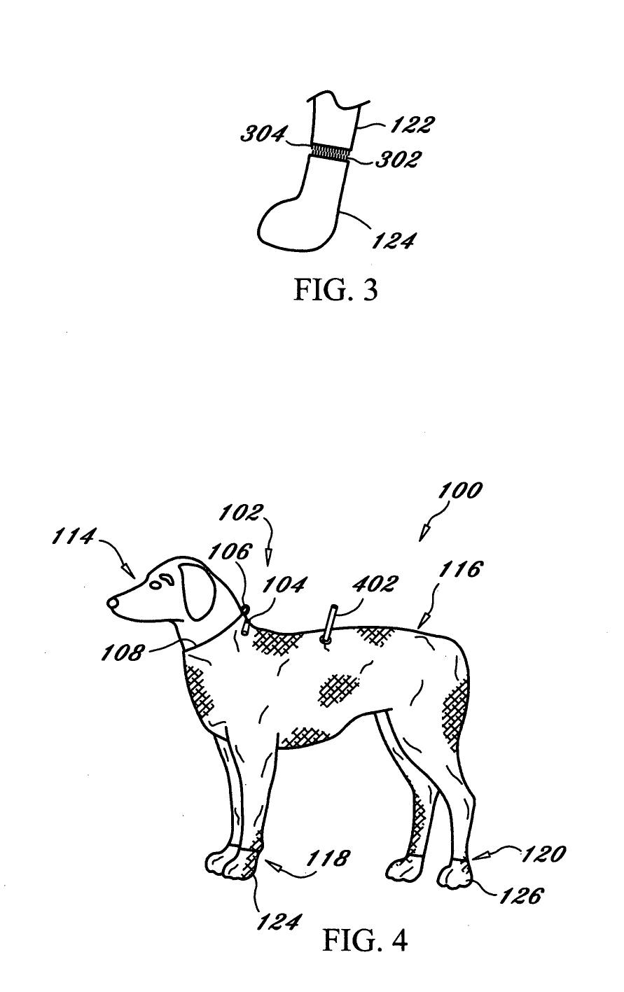

In one embodiment, shown in FIG. 3, front feet portion 124 and hind feet portion 126 (not shown) are removable and contain feet attachment means 302. Feet attachment means 302 may be adhesive or one part of a mechanical attachment means such as one or more snaps, buttons, zippers, hook-and-loop fasteners such as Velcro®, magnets, or any other mechanical fastener that requires the mating of two parts.

If feet attachment means 302 is one part of a mechanical attachment means, then body portion 122 contains mating feet attachment means 304. Mating feet attachment means 304 is the mating part of feet attachment means 302. For example, if feet attachment means 302 is a button, then mating feet attachment means 304 may be a button hole.

By allowing front feet portion 124 and hind feet portion 126 to be removable, the feet of canine 100 can be cleaned to allow canine 100 to walk to an area such as a bathroom where the rest of canine 100 can be easily cleaned. In addition front feet portion 124 and hind feet portion 126 may contain pads or reinforcement to reduce the wear on front feet portion 124 and hind feet portion 126 and to reduce the effects of canine's 100 nails.

In an alternate embodiment, shown in FIG. 4, apparel 102 contains intake means 402. Intake means may be a hose, sealable flap, or other means for gaining access to canine 100 when canine 100 is enclosed in apparel 102. By allowing access to canine 100, medicine such as flee spray or powder can be applied. Also, apparel 102 can be used in place of an Elizabethan collar for canines who are recovering from an ailment such as surgery with stitches, with hot spots (acute moist dermatitis), dermatitis, allergies that cause skin eruptions, itching, other skin problems or who are recovering from surgery. Because apparel 102 is breathable, canine 100 can wear apparel 102 for an extended time to allow the injured, infected or otherwise stressed area to heal.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims. For example, the underwear described above could be easily modified for men and such a modification would be apparent to one skilled in the art.

1. A lightweight, washable, durable, breathable article that can relatively easily enclose a canine and keep a vehicle, house, or other enclosure relatively clean of dander, mud, dirt, water or other material, the apparel comprising:
a body portion that substantially covers the body of a canine;
a front feet portion that covers the front feet of the canine wherein each front feet portion is removable from the body portion;
a hind feet portion that covers the hind feet of the canine wherein each hind feet portion is removable from the body portion; and
a closure means for securing the apparel around the canine
wherein the apparel is made of a relatively lightweight, washable, relatively durable, breathable material.

2. The article of claim 1 wherein the material is nylon.

3. The article of claim 1 wherein material is breathable neoprene.

4. The article of claim 1 wherein the closure means is a mechanical fastener.

5. The article of claim 4 wherein the mechanical fastener is one or more snaps, buttons, zippers, hook-and-loop fasteners, or magnets.

6. The article of claim 1 wherein the body portion contains elastic to assist in securing the article around the canine's neck.

7. The article of claim 1 wherein the body portion contains a leash attachment.

8. The article of claim 7 wherein the lease attachment is a D-ring.

9. The article of claim 1 wherein the body portion contains lifting straps.

10. (canceled)

11. A disposable article that can relatively easily enclose a canine and keep a vehicle, house, or other enclosure relatively clean of dander, mud, dirt, water or other material, the apparel comprising:
a body portion that substantially covers the body of a canine;
a front feet portion that covers the front feet of the canine wherein each front feet portion is removable from the body portion;
a hind feet portion that covers the hind feet of the canine wherein each hind feet portion is removable from the body portion;
a closure means for securing the apparel around the canine; and
wherein the apparel is made of a disposable material.

12. The article of claim 11 wherein the material is paper backed with plastic.

13. The article of claim 11 wherein the closure means is a mechanical fastener.

14. The article of claim 13 wherein the mechanical fastener is one or more snaps, buttons, zippers, hook-and-loop fasteners, or magnets

15. The article of claim 11 wherein the body portion contains elastic to assist in securing the article around the canine's neck.

16. A lightweight, washable, durable, breathable article that can relatively easily enclose a canine and allow for the application of medicine, the apparel comprising:
a body portion that substantially covers the body of a canine;
a front feet portion that covers the front feet of the canine wherein each front feet portion is removable from the body portion;
a hind feet portion that covers the hind feet of the canine wherein each hind feet portion is removable from the body portion;
a closure means for securing the apparel around the canine; and
an access means for accessing the canine for the application of medication
wherein the apparel is made of a relatively lightweight, washable, relatively durable, breathable material.

17. The article of claim 16 wherein the material is nylon.

18. The article of claim 16 wherein material is breathable neoprene.

19. The article of claim 16 wherein the closure means is a mechanical fastener.

20. The article of claim 19 wherein the mechanical fastener is one or more snaps, buttons, zippers, hook-and-loop fasteners, or magnets.
